(19) United States
(12) Patent Application Publication
(10) Pub. No.: US 2006/0039417 A1
(43) Pub. Date: Feb. 23, 2006

(54) Compact system and method for the production of long-wavelength, electromagnetic radiation extending over the terahertz regime

(75) Inventors: Sandra Gail Biedron, Chicago, IL (US); Stephen Val Milton, Chicago, IL (US); John W. Lewellen, Plainfield, IL (US)

Correspondence Address: JOAN PENNINGTON, 535 NORTH MICHIGAN AVENUE, UNIT 1804, CHICAGO, IL, 60611, US

(73) Assignee: THE UNIVERSITY OF CHICAGO

(21) Appl. No.: 11/153,815

(22) Filed: Jun. 15, 2005

Related U.S. Application Data
(60) Provisional application No. 60/602,100, filed on Aug. 17, 2004.

(51) Int. Cl. H01S 3/00

(52) U.S. Cl. 372/2

(57) ABSTRACT

A compact system and method are provided for implementing the generation of electromagnetic radiation extending over mm-wavelength to sub-mm-wavelength or terahertz range. The generated electromagnetic radiation can be broadband or have a variable bandwidth. Electrons are accelerated to a chosen energy and undergo subsequent or simultaneous temporal or spatial compression. The degree of compression is chosen such that the electron beam pulse length is near to or less than that of the terahertz wavelength desired to be generated. The radiation is produced by one or combination of methods of synchrotron radiation or transition radiation.

This application claims the benefit of U.S. Provisional Application No. 60/602,100, filed on Aug. 17, 2004.

### CONTRACTUAL ORIGIN OF THE INVENTION

The United States Government has rights in this invention pursuant to Contract No. W-31-109-ENG-38 between the United States Government and Argonne National Laboratory. The invention was partially funded by the United States Department of Agriculture-Animal and Plant Health Inspection Service (USDA-APHIS) under Interagency Agreement No. 0381000826-1A.

### FIELD OF THE INVENTION

The present invention relates to a compact system and method for implementing the generation of electromagnetic radiation extending over mm-wavelength to sub-mm-wavelength or terahertz regime using compressed electrons beams and standard accelerator system components.

### DESCRIPTION OF THE RELATED ART

Experiments using Free Electron Laser (FEL) facilities, such as the Low-Energy Undulator Test Line (LEUTL) at Argonne National Laboratory (ANL) have demonstrated that it is feasible to extract energy from electrons in the form of coherent light. This emission of light from the electrons is either via the synchrotron radiation or transition radiation process. In this device, the electrons were compressed to the order of the wavelength of the output electromagnetic radiation in the complicated and space-consuming FEL interaction. However, these earlier experiments were carried out at shorter wavelengths than the terahertz wavelength regime under investigation and therefore required the space-consuming FEL process for the coherent emission from synchrotron radiation and transition radiation to be achieved.

In traditional compact terahertz-generating systems, the difficulty is generating sufficient average and peak powers. For example, laser-based systems produce a factor of at best 1,000 times less average and peak power than the described invention. Similarly, solid state and traveling wave tube (TWT) based devices produce at best 1,000 times less average and peak power than the described invention. Furthermore, in the cases of both laser-based systems and solid state and traveling wave tube (TWT) based devices, the systems are 1) not continuously tunable over the full mm- to sub-mm-wave wavelength regime, 2) cannot compete with the power levels produced in the described invention, 3) cannot be fully tunable in the bandwidth of the output wavelength (i.e., broad-band and narrow-band).

A principal object of the present invention is to provide a compact system and compact method for implementing the generation of tunable electromagnetic radiation extending over mm-wavelength to sub-mm-wavelength or the terahertz range and to provide simultaneously a chosen bandwidth or temporal structure to the radiation.

### SUMMARY OF THE INVENTION

In brief, a compact system and method are provided for implementing the generation of tunable electromagnetic radiation extending over mm-wavelength to sub-mm-wavelength or terahertz range. The generated electromagnetic radiation can be broadband or have a variable bandwidth or have a specialized temporal structure. Electrons are accelerated to a chosen energy and undergo subsequent temporal or spatial compression. The degree of compression is chosen such that the electron beam pulse length is near to or less than that of the terahertz wavelength desired to be generated. The radiation is produced by a selected one or combination of methods of synchrotron radiation or transition radiation.

This invention capitalizes on the compression of an electron beam in the described compact system and on the method of making this compressed electron beam radiate effectively and coherently. The pre-compressed electron beam from this compact system readily generates intense, coherent, electromagnetic radiation using the method of synchrotron radiation and/or transition radiation in a compact manner. The degree of pre-compression can be chosen by the user to tailor the output radiation. The output wavelength of the electromagnetic radiation can be tuned and chosen by the user. The output bandwidth can also be chosen based upon the type of device chosen to induce radiation from the electron bunch. The output temporal structure of the resulting electromagnetic wave can be tailored as desired.

In the case of the compact synchrotron radiation method, the compressed electron bunches are then passed through one or more magnetic fields that transversely accelerates the compressed beam. Depending upon the electron beam energy and energy spread, the degree of compression, and the periodicity, amplitude, and number of oscillation periods experienced by the electron bunch within the magnetic field, the output wavelength, bandwidth, and temporal structure can be tailored and determined.

In the case of the compact transition radiation method, the electrons are passed through a conductor or series of conductors. Depending upon the electron beam energy, the degree of compression, and the spacing of the possible multiple conductor plates, the output wavelength, bandwidth, and temporal structure can be tailored and determined.

In accordance with features of the invention, a compact, efficient, robust, ultra-high power terahertz source is provided with many utilities including but not limited to defense, security, basic sciences, medicine, and food safety. A unique compact device of the invention is capable of generating long-wavelength, such as 5 mm to 20 microns, electromagnetic radiation or electromagnetic terahertz radiation.

In accordance with features of the invention, for either case of the compact synchrotron radiation method or the compact transition radiation method, a significant fraction of the power of the electron beam is converted to electromagnetic terahertz radiation. Both methods rely on coherent emission radiation by an ensemble of relativistic electrons. Since the electron beam is pre-compressed, the output radiation scales as the square of the number of particles in the bunch instead of linearly. The average electron beam power can be very high compared to a laser-based system, a solid state system, or a traveling wave tube (TWT) based device.

In accordance with features of the invention, enhanced efficiency of the compact system is obtained by recovering radio-frequency power from spent electron beam and using the recovered radio-frequency power to accelerate fresh electron brunches; while this is not a requirement for the compact system to efficiently produce electromagnetic radiation.

The compact system includes an accelerator that may be either normal conducting or superconducting, for purposes of system simplicity or improved operational efficiency, respectively.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a schematic and flow diagram illustrating an exemplary system for implementing methods of the invention for the generation of electromagnetic radiation extending over mm-wavelength to sub-mm-wavelength or terahertz range in accordance with the preferred embodiment; and

FIGS. 2 and 3 are charts illustrating exemplary results using the transition radiation method in the system of FIG. 1 in accordance with the preferred embodiment.

### DETAILED DESCRIPTION OF THE PREFERRED EMBODIMENTS

Extracting energy in the form of electromagnetic radiation from charged particles, such as electrons, is well documented in theory, simulation, and experiment. In theory, one can completely tailor the wavelength and quality (transverse and longitudinal coherence) of electromagnetic radiation produced via synchrotron radiation or transition radiation from charged particles.

Whenever a charged particle undergoes acceleration it radiates electromagnetic energy. A common example is the emission of radio waves when electrons move back and forth in a radio antenna. A charged particle traveling in the arc of a circle, due to its change in direction is also undergoing acceleration. When electrons traveling at close to the speed of light are bent in magnetic fields, more accurately described in physics as being transversely accelerated, the radiation emitted by such particles is called synchrotron radiation and is particularly intense and very directional.

Another way of producing electromagnetic radiation from a charged particle is via transition radiation. Transition radiation is produced when a relativistic particle traverses a conductive medium, such as a mirror. Image charges are generated in the conductive medium which accelerate to meet the electron beam at the surface. This acceleration results in a burst of electromagnetic radiation called transition radiation. The intensity of this transition radiation is roughly proportional to the electron beam's energy.

The electromagnetic fields generated by multiple electrons undergoing acceleration do not necessarily add up linearly. Depending on the wavelength of the radiation and position of the electrons relative to one another, the electromagnetic fields can add up constructively, can interfere and cancel out, or can be somewhere in between. If the fields add up constructively, the result is called coherent emission. This is achieved when the wavelength of interest is equal to or shorter than the spacing between electrons. Coherent emission can result in very dramatic increases in the output power of an ensemble of electrons versus the ensemble emitting incoherently. This coherent emission can be expressed in either or both synchrotron radiation emission or in transition radiation emission.

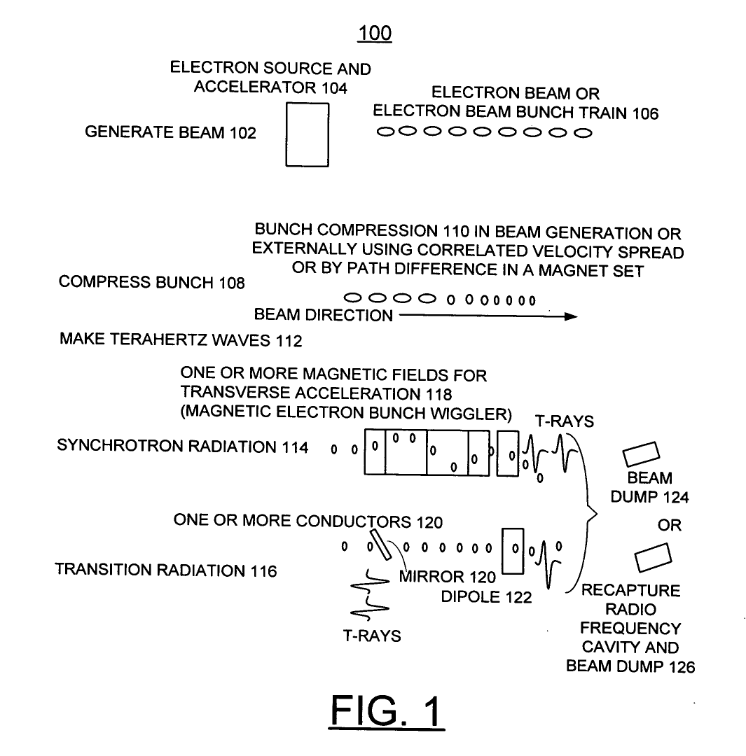

Having reference now to the drawings, FIG. 1 illustrates an exemplary and compact system for implementing methods of the invention for the generation of electromagnetic radiation extending over mm-wavelength to sub-mm-wavelength or terahertz range in accordance with the preferred embodiment generally designated by the reference character 100.

In accordance with features of the invention, a compact source for implementing methods of the invention is able to fit into a volume no greater than 33 cubic meters. An example of such is a standard 20 foot shipping container with external dimensions of 20 feet by 8 feet by 8 feet six inches, or in metric units 6.1 meters by 2.4 meters by 2.6 meters.

Terahertz radiation generation compact system 100 includes means for implementing a first method step of 1) Generate Beam 102, an electron source and accelerator 104 producing an electron bunch or electron beam bunch train 106 in the low Million electron Volt (MeV) energy range. The accelerator 104 can be normal conducting for purposes of system simplicity or can be superconducting for purposes of improved operational efficiency.

Terahertz radiation generation compact system 100 includes means for implementing a second method step of 2) Compress Bunch 108, including a bunch compression block or bunch compressor 110. For compressing the electron bunches or the electron bunches in the electron bunch train 106, a path length difference method or a correlated electron velocity spread can be used. In the first case, the path length difference method, an induced correlated energy spread across the bunch will be used to create path length differences when traveling through a magnetic channel. Properly chosen parameters of the energy spread and magnet settings result in a compressed electron bunch. In the second case, the correlated electron velocity spread method, a properly controlled induced correlated velocity spread on the electron bunch forces the electron bunch to self-compress. This induced correlated velocity spread is created by a differential acceleration as provided by, for example, an oscillating high electric gradient. This compressed bunch length is on the order of or less than the electromagnetic terahertz wavelength radiation to be produced in 112 below. It should be understood that the electron source and accelerator 104 and the beam compression 108 are not necessarily mutually exclusive. A combined function system may serve to both generate and compress the beam.

Terahertz radiation generation compact system 100 includes means for implementing a third method step of 1) Make terahertz electromagnetic waves 112, including the method of synchrotron radiation 114 and/or the method of transition radiation 116 for generating the terahertz radiation.

The bunch compression 110 of the electron beam provides a compressed electron beam that radiates effectively and coherently. The extensive Free Electron Laser (FEL) interaction is not required to produce the necessary electron beam compression and therefore the system is compact. The pre-compressed electron beam or electron beam bunch train 106 produced by system 100 readily generates intense, coherent, electromagnetic radiation using the method of synchrotron radiation 114 and/or transition radiation 116. The degree of pre-compression can be chosen by the user to tailor the output radiation. The output wavelength of the electromagnetic radiation can be tuned and chosen by the user. This is done primarily through the choice of electron beam energy, but can also be accomplished by variation of electron beam bunch properties or emission process parameters. The output bandwidth can also be chosen based upon the method and type of device chosen to induce radiation from the electron bunch.

For the synchrotron radiation method 114, the electrons are then placed into one or more magnetic fields that transversely accelerates the compressed beam. A magnetic electron bunch wiggler 118 can be used to produce the magnetic field that transversely accelerates the compressed beam and provides the desired output terahertz waves. Alternatively or in conjunction, a dipole 122, can be used to produce synchrotron radiation. Depending upon the electron beam energy, the degree of compression, and the periodicity, amplitude, and number of oscillation periods experienced by the electron bunch within the magnetic field, the output wavelength and bandwidth can be tailored and determined.

For the transition radiation method 116, the electrons are passed through a conductor or series of conductors 120. These conductors 120 can be solid for the electron-beam-disrupting coherent radiation method or they can have a small hole in which the electron beam can pass without disrupting the electron beam; otherwise known as the coherent diffraction transition radiation method. This acceleration results in a burst of electromagnetic radiation called transition radiation. Transition radiation is produced when a relativistic particle traverses a conductive medium, such as a mirror 120. The intensity of this coherent transition radiation is roughly proportional to the particle energy and is somewhat less intense for the coherent diffraction transition radiation version. Depending upon the electron beam energy of the generated beam 102, the degree of compression from the bunch compression 110, and the spacing of the possible multiple conductors 120, the output wavelength and bandwidth can be tailored and determined.

In either or both compact methods of generating terahertz electromagnetic radiation via synchrotron radiation and/or transition radiation, a means for eliminating the presence of the electron beam after emitting electromagnetic terahertz radiation is provided by the addition of a separate dipole magnet 122 that deflects the electron beam into a dump 124. The electron beam can alternatively be sent to a recapture radio-frequency cavity and dump 126 so the power of the e-beam can be re-used to conserve on energy and improve overall efficiency. This separate dipole magnet 122 can be placed in a location either before or after the terahertz radiation is picked off by a mirror (not shown) and reflected to the place where the beam will be used or is of interest.

In brief, compact system 100 converts a significant fraction of the power of the electron beam to electromagnetic radiation. The method of the invention relies on coherent emission of radiation by an ensemble of relativistic electrons. Since the electron beam is pre-compressed, the output radiation scales as the square of the number of particle in the bunch instead of linearly. For example, in a typical type of accelerator system for implementing the electron source and accelerator 110, 10**9 electrons per bunch is a modest or conservative number for the electron bunch or electron beam bunch train 106. For coherent emission approximately 1% of the electron beam power is converted into terahertz radiation.

In a recent experiment, we measured the terahertz radiation generated using the transition radiation compact method. Based on the calibration of the pyrodetector, which assumes a flat response from the detector, we have produced 10 W of transition radiation power during the macropulse, or a time-average power of 64 microWatts at a 6 Hz repetition rate and a 1.6 microsecond bunch bunch train. Following this demonstration, we introduced cathode laser emission gating and demonstrated an increase in beam currents of a factor of 100. We believe we now have approximately 0.5 MW of peak terahertz power.

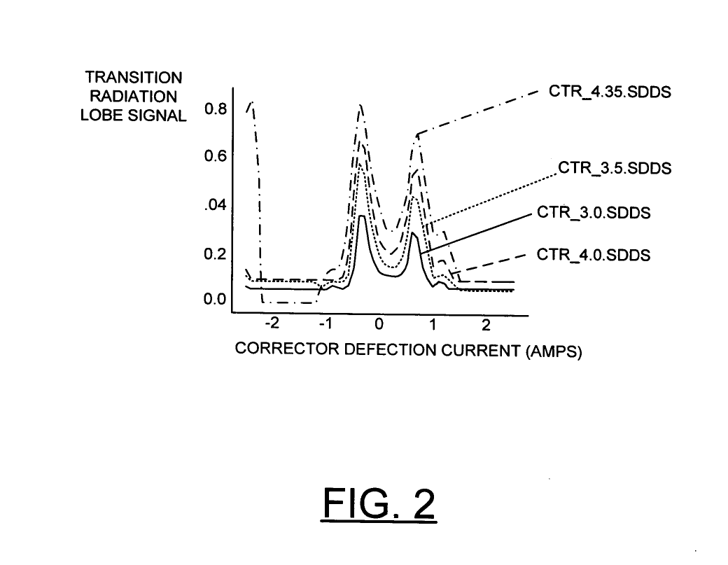

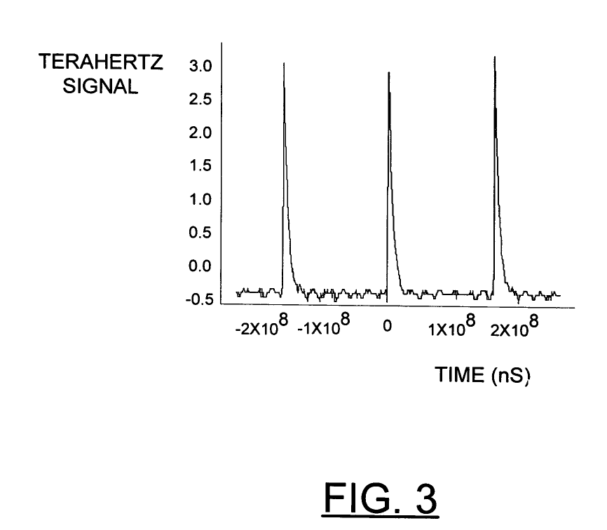

Referring to FIGS. 2 and 3, there are shown exemplary results using compact transition radiation 116 off a conductor 120. The transition radiation lobes and the detector signal (both arbitrary energy units) can be seen in FIGS. 2 and 3, respectively. The radiation pattern in FIG. 2 consists of an annular ring with peak intensities (lobes) occurring at an angle defined by the ratio of the particle energy to its rest mass energy. The respective traces labeled CTR_{—}3.0.5DDS, CTR_{—}3.5.5DDS, CTR_{—}4.0.5DDS, and CTR_{—}4.35.5DDS illustrate different electron beam voltages or beam energies. The overlapping peaks are a characteristic signature of transition radiation. The overlapping peaks, with profiles that scale as beam energy also provide a characteristic signature of transition radiation. FIG. 3 illustrates a terahertz detector signal (arbitrary units) versus time (ns). In the illustrated temporal structure of the terahertz radiation pulses, each spike corresponds to an accelerator macropulse.

Currently there exists a great need for high-power terahertz systems for a variety of applications. The currently available low power terahertz sources have proven the utility of the terahertz frequency band. Applications for terahertz radiation include but is not limited to the development of terahertz sensors, scientific applications of terahertz spectroscopy, imaging with single-cycle terahertz pulses, defense and security application of mm-wave and terahertz radiation, and medical applications of terahertz. The list of applications is extensive and includes but is not limited to; spectroscopy, sensing, imaging, and communications for space science; spectroscopy, imaging (near and far field), and pump/probe for basic science; new terrestrial communications; spectroscopy, sensing, and imaging in industrial applications; applications in medicine; and sensing, imaging, ranging, and communications in government/defense and security.

It should be understood that the present invention is not limited to the illustrated terahertz radiation generation compact system 100. Terahertz radiation generation compact system 100 provides a basic, proof-of-principle example of a compact terahertz system of the invention.

It should be understood that the electron beam generation and/or pre-compression can occur at any RF frequency, and is not limited to the reduction to practice that operates at 2856 MHz.

It should be understood that the electron beam source and accelerator 104 can employ a photocathode, thermionic cathode source, filed emission source, or other equivalent electron source of which the latter three may be laser assisted or using a laser to provide all gated emission, and is not limited to the operation of a thermionic source, field emission source, or other equivalent electron source. The source may be operated as a normal-conducting or warm system or a superconducting or cold system.

It should be understood that to increase the system's efficiency, the source may also be operated in a re-circulating mode of operation where the RF power is “recaptured” in a cavity and re-used.

While the present invention has been described with reference to the details of the embodiments of the invention shown in the drawing, these details are not intended to limit the scope of the invention as claimed in the appended claims.

What is claimed is:

1. A compact system for implementing the generation of electromagnetic radiation extending over mm-wavelength to sub-mm-wavelength or terahertz range comprising:
an electron source and accelerator for generating an electron beam and accelerating electrons to a selected energy;
a bunch compressor for bunch compressing said electron beam by a selected degree of compression; said degree of compression being selected to provide an electron beam pulse length near or less than a desired terahertz wavelength to be generated; and
an electromagnetic radiation function for generating the electromagnetic radiation; said electromagnetic radiation function including a selected one or a combination of a synchrotron radiation method and a transition radiation method.

2. A compact system as recited in claim 1 wherein said electron source and accelerator generates an electron bunch or electron beam bunch train at an energy in a MeV range.

3. A compact system as recited in claim 1 wherein said electron source includes a selected one of a photocathode, a thermionic cathode source, or a field emission source.

4. A compact system as recited in claim 3 wherein said thermionic cathode source and said field emission source includes a laser for gated emission.

5. A compact system as recited in claim 1 includes one or more compact methods of compressing the electron beam to enable coherent production of electromagnetic radiation though one or both methods of synchrotron radiation and transition radiation.

6. A compact system as recited in claim 1 wherein said synchrotron radiation method includes one or more magnetic fields that transversely accelerates the compressed beam for providing desired output terahertz waves.

7. A compact system as recited in claim 1 wherein said transition radiation method includes at least one conductor for accelerating the compressed beam for providing desired output terahertz waves.

8. A compact system as recited in claim 7 wherein said transition radiation method includes a series of conductors and said series of conductors having a selected spacing for providing a selected output terahertz wavelength.

9. A compact system as recited in claim 1 wherein said generated electromagnetic radiation has variable bandwidth including broadband and narrowband or temporally tailored pulse of electromagnetic radiation.

10. A compact system as recited in claim 1 wherein said accelerator includes one of a normal conducting accelerator or a superconducting accelerator.

11. A method for implementing the generation of electromagnetic radiation extending over mm-wavelength to sub-mm-wavelength or terahertz range comprising the steps of:
generating an electron beam and accelerating electrons to a selected energy;
performing bunch compression of said electron beam by a selected degree of compression; said degree of compression being selected to provide an electron beam pulse length near or less than a desired terahertz pulse length to be generated;
utilizing a selected one or a combination of a synchrotron radiation method and a transition radiation method for generating the electromagnetic terahertz radiation.

12. A method for implementing the generation of electromagnetic radiation as recited in claim 11 wherein the step of generating an electron beam and accelerating electrons to a selected energy includes the step of generating an electron bunch or electron bunch beam bunch train at an energy in a MeV range.

13. A method for implementing the generation of electromagnetic radiation as recited in claim 11 wherein the step of generating an electron beam and accelerating electrons to a selected energy includes the step of providing a selected one of a photocathode, a thermionic cathode source, or a field emission source.

14. A method for implementing the generation of electromagnetic radiation as recited in claim 11 wherein the step of performing bunch compression of said electron beam by a selected degree of compression includes the step of providing an electron bunch compressor for performing bunch compression of said electron beam.

15. A method for implementing the generation of electromagnetic radiation as recited in claim 11 wherein the step of utilizing a selected one or a combination of said synchrotron radiation method and said transition radiation method for generating the electromagnetic terahertz radiation includes the step of utilizing said transition radiation method and providing at least one conductor for providing desired output terahertz electromagnetic radiation.

16. A method for implementing the generation of electromagnetic radiation as recited in claim 11 wherein the step of utilizing a selected one or a combination of said synchrotron radiation method and said transition radiation method for generating the electromagnetic terahertz radiation includes the step of utilizing said transition radiation method and providing a series of conductors such as mirrors for providing desired output terahertz electromagnetic radiation wavelength and bandwidth since the said series of conductors have a selected spacing for providing a selected output terahertz wavelength.

17. A method for implementing the generation of electromagnetic radiation as recited in claim 11 wherein the step of utilizing a selected one or a combination of said synchrotron radiation method and said transition radiation method for generating the electromagnetic radiation includes the step of utilizing said synchrotron radiation method and providing one or more magnetic fields that transversely accelerates the compressed beam to provide desired output terahertz electromagnetic radiation.

18. A method for implementing the generation of electromagnetic radiation as recited in claim 11 includes the step of passing a spent electron beam through a radio-frequency power recovery system.
